(19) United States
(12) Patent Application Publication
(10) Pub. No.: US 2015/0051920 A1
(43) Pub. Date: Feb. 19, 2015

(54) SYSTEM AND METHOD FOR COMMUNICATION BETWEEN HUB, OFFICE, AND LABORATORY

(71) Applicant: Thi Tran, Clearwater, FL (US)

(72) Inventor: Thi Tran, Clearwater, FL (US)

(73) Assignee: SOHI, LLC, Clearwater, FL (US)

(21) Appl. No.: 14/460,959

(22) Filed: Aug. 15, 2014

Related U.S. Application Data
(60) Provisional application No. 61/866,676, filed on Aug. 16, 2013.

(51) Int. Cl. G06F 19/00

(52) U.S. Cl. CPC G06F 19/3418; G06F 19/322; G06F 19/321
USPC 705/3

(57) ABSTRACT

Systems and methods of the invention relate to maintaining validation of information communicated from a physician to a laboratory for performance of a test. A hub component is configured to manage data streams between an office environment and a laboratory environment. The order request can be communicated to the laboratory while maintaining particular information supplied by a physician at the office environment. Once a test result is complete and received by the hub component, the hub component can communicate the test result to the office environment.

### CROSS-REFERENCE TO RELATED APPLICATIONS

This application claims priority to U.S. Provisional Application Ser. No. 61/866,676, filed Aug. 16, 2013, entitled “SYSTEM COMMUNICATIONS BETWEEN HUB, OFFICE, AND LABS”, the entirety of which is herein incorporated by reference.

### BACKGROUND OF THE INVENTION

1. Field of the Invention

This application relates generally to communication between an office and laboratory and, more specifically, to systems and methods for managing communications between a private physician office environment and a lab environment.

2. Description of Related Art

Diagnostic laboratories provide diagnostic testing services to physicians and can often be located remotely and/or organizationally separate from private offices maintained by the physicians. Often, a patient is provided with an order request from a physician during an office visit. The patient travels to a laboratory location with the order request to provide samples on which diagnostic tests are performed in accordance with the order request. Results of the diagnostic tests are sent back to the physician. Alternatively, the samples can be acquired at the physician's office and subsequently couriered to the laboratory along with the order request.

### BRIEF SUMMARY OF THE INVENTION

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

According to one embodiment, a method for communication between a physician office and a laboratory is described. The method includes receiving, form the physician office, an electronic data package associated with a patient and an order request indicating one or more diagnostic tests to be performed. The method further includes removing patient identification information from the electronic data package and the order request. In addition, the method can include transmitting the electronic data package and the order request, with patient identification information removed, to the laboratory. Further, the method includes receiving results of the one or more diagnostic tests from the laboratory, and transmitting the electronic data package and the results to the physician office.

In an embodiment, a method is provided that includes at least the steps of: creating an electronic file for a patient that includes dermatology information associated with the patient; embedding a digital image of a portion of the patient with the electronic file to create an electronic dermatology package; communicating the electronic dermatology package and an order request from a first location that collected the digital image to a hub location, wherein the order request relates to performing one or more tests from a laboratory; removing personal information that identifies the patient from the electronic dermatology package; associating a unique identification to the electronic dermatology package in replacement of personal information that identifies the patient, wherein the unique identification corresponds to the patient; communicating the order request, the electronic dermatology package without personal information that identifies the patient, the unique identification, and a physical sample of the patient to the laboratory to perform one or more tests on the physical sample; receiving a test result of the physical sample from the laboratory based upon the communication of the order request, the electronic dermatology package, the unique identification, and the physical sample; appending personal information that identifies the patient to the electronic dermatology package and the test result based upon a matching of the unique identification to the patient; and communicating the electronic dermatology package with personal information that identifies the patient, and the test result to the first location that collected the digital image.

In an embodiment, a method of validating information from a physician for a patient file is provided that includes at least the steps of: embedding a digital image of a portion of the patient with an electronic file to create an electronic dermatology package; communicating the electronic dermatology package, a biopsy of the patient, and an order request, wherein the order request relates to performing a test on the biopsy from a laboratory; removing personal information that identifies the patient from the communication; communicating the order request, the electronic dermatology package without personal information, and the biopsy to the laboratory; receiving a test result of the biopsy from the laboratory; adding personal information that identifies the patient to the test result; and communicating the electronic dermatology package with personal information, and the test result to the first location that collected the digital image.

These and other embodiments are described in more detail below.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an embodiment of a system for validating patient information during requests for laboratory results;

FIG. 2 is an illustration of an embodiment of a system for validating patient information during requests for laboratory results;

FIG. 3 is an illustration of an embodiment of a system for maintaining confidentiality of patient information with a request for a laboratory test;

FIG. 4 illustrates a flow chart of an embodiment of a method for communicating a request to a laboratory;

FIG. 5 illustrates a flow chart of an embodiment of a method for validating information from a physician for a patient file; and

FIG. 6 is a schematic block diagram illustrating a suitable operating environment for aspects of the subject disclosure.

### DETAILED DESCRIPTION OF THE INVENTION

Embodiments of the invention relate to methods and systems for maintaining validation of information communicated from a physician to a laboratory for performance of a test. A hub component is configured to manage data streams between an office environment and a laboratory environment. The hub component can receive order request to perform a test at a laboratory and remove personal information therefrom. The order request can be communicated to the laboratory while maintaining particular information supplied by a physician at the office environment. Once a test result is complete and received by the hub component, the hub component can communicate the test result to the office environment, wherein the communication includes personal information, the test result, and the particular information. It is to be appreciated that the communication from the hub component to the laboratory may not include personal information but rather the order request and the particular information supplied by the physician. In other words, the information supplied by the physician at the office environment is validated during the communications between the office environment, the hub component, and the laboratory environment.

With reference to the drawings, like reference numerals designate identical or corresponding parts throughout the several views. However, the inclusion of like elements in different views does not mean a given embodiment necessarily includes such elements or that all embodiments of the invention include such elements.

The term “component” as used herein can be defined as a portion of hardware, a portion of software, or a combination thereof. A portion of hardware can include at least a processor and a portion of memory, wherein the memory includes an instruction to execute.

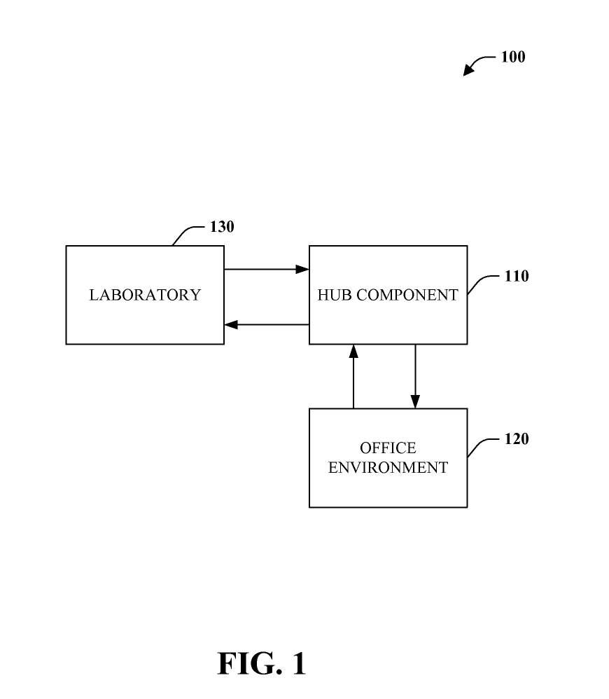

FIG. 1 illustrates a system 100 for validating patient information during requests for laboratory results. The system 100 includes a hub component 110 that is configured to manage data streams between an office environment 120 (also referred to as an office) and a laboratory 130 (also referred to as a laboratory environment). The hub component 110 is configured to manage data streams therebetween by implementing at least one of data authentication, data validation, data encryption, data decryption, adding or removing data to a data stream, among others. Moreover, the hub component 110 can ensure validity of a data stream communicated from the office 120 as well as receipt of a data stream from the laboratory 130. In particular, a portion of data in a data stream can be created and such data can be maintained during communications, transmissions, data appending, data removal, among others independent of transmission and/or receipt from at least one of the hub component 110, the office 120, and/or the laboratory 130.

In an embodiment, the office environment 120 can be a dermatology office in which one or more physicians examine and provide care to patients in the medical field of at least dermatology. The office environment 120 can include one or more physicians, wherein each patient can include a respective chart or file. It is to be appreciated that a chart or a file for a patient can be any suitable collection of information (e.g., hard copy, soft copy, a combination thereof) collected from the patient directly and/or indirectly from at least one of an interview of the patient, an examination of the patient, an insurance company of the patient, a parent of the patient, a guardian of the patient, an insurance card, a transfer file from another physician, an electronic communication from the patient, and/or any other suitable source that provides patient information. The collection of information can be tabulated or collected as an electronic file for the patient. For instance, a hard copy of a file for a patient can be electronically scanned to create an electronic file. Following such example, additional information collected or identified during an examination can be appended to the electronic file during intake with an electronic device. In another example, an electronic file for a patient can be gathered and aggregated via an electronic device (e.g., tablet, computer, handheld, among others). It is to be appreciated and understood that the intake of patient data or aggregation of patient data can include a conversion of hard copy files or charts, electronic intake of patient data, electronic intake for files or charts, and/or any suitable combination thereof

In an embodiment, the laboratory 130 can be a facility or environment that can perform one or more tests for a patient at a request of the office environment 120. For instance, the request can be an order request from a physician to perform a test. In a particular example, the order request can be from a physician to perform a pathology test on a biopsy sample obtained from a patient.

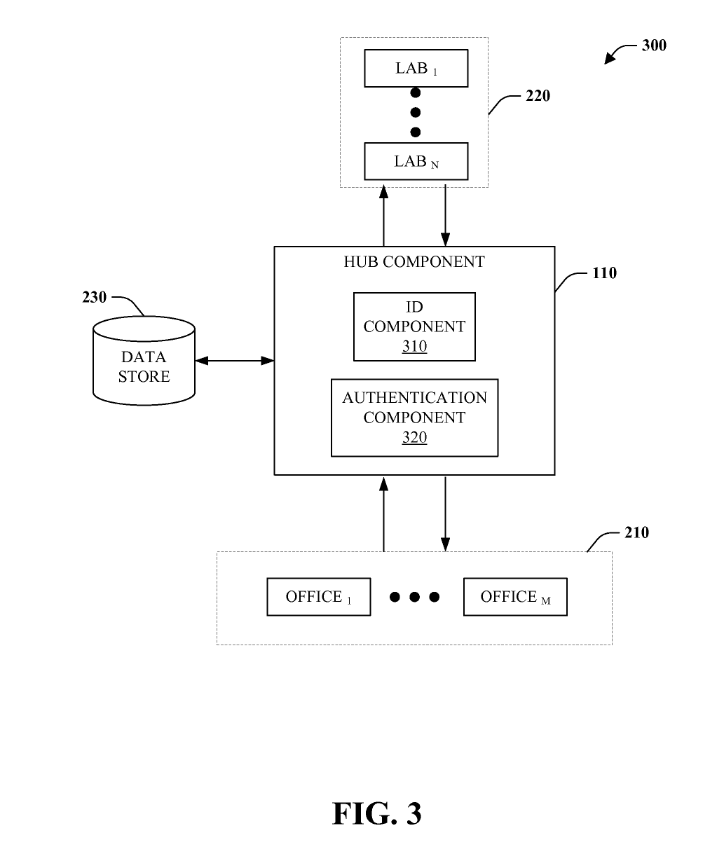

As mentioned above, the hub component 110 can manage data streams between the office environment 120 and the laboratory 130. In particular, the hub component 110 can receive a data package from the office environment 120, wherein the data package includes data from a physician during a physical examination. The data package can include data from an electronic file associated with the patient (described below), information associated with the provider (i.e., the physician), as well as insurance information, for example. Thus, the data package enables linking a condition, a provider, and a patient along with service rendered (e.g., pathology services, treatment services). This linking enables rapid identification of a problem as an original condition or an established condition, which can influence reimbursement decisions from insurance carriers or other coverage systems (e.g., Medicare, Medicaid, etc.). The hub component 110 maintains data integrity for the data from the physician during communications. Moreover, the hub component 110 is further configured to remove patient identifying information (e.g., personal information for a patient) during transmission to the laboratory 130. In an example, the hub component 110 can generate a unique identifier (e.g., a globally unique identifier (GUID)) for each patient such that the unique identifier replaces any personal information of the patient or patient identifying information (e.g., name, social security number, address, health insurance identification, among others) (see below in FIG. 3). The hub component 110 can store the unique identifier in correspondence with patient identification information to facilitate anonymizing and/or deanonymizing patient data communicated between the laboratory 130 and the office environment 120. According to an further aspect, it is to be appreciated that the hub component 110 can generate a unique identifier for each order request and associated the generated unique identifier with patient identification information corresponding to the order request. Thus, additional privacy protection is provided through prevention of reuse of unique identifiers. In another embodiment, the hub component 110 is configured to provide secured communications between the office environment 120 and the laboratory 130, wherein communication can refer to transmission from the office environment 120 to the hub component 110 to the laboratory 130 and/or transmission from the laboratory 130 to the hub component 110 to the office environment 120 (see below in FIG. 3).

In an embodiment, a physician can add information to an electronic file for a patient, wherein the information can be, for instance, a digital image, an annotation, a digital image of a patient that captures a dermatological condition on skin, among others. Co-pending application No. ______, incorporated herein by reference, describes one exemplary technique for acquiring and incorporating the digital image. The physician can determine that a test should be performed for the patient and can create an electronic dermatology package. It is to be appreciated that the electronic dermatology package can include data from the electronic file for the patient that is defined by the physician from the office environment 120. For instance, the physician can determine that a first test can include information A, B, and C to be included in the electronic dermatology package, whereas a second test can include information B, D, F, and G in the electronic dermatology package. It is to be appreciated that any suitable data can be defined to include in the electronic dermatology package. Yet, the information defined to include in the electronic dermatology package is by the physician and once defined, the hub component 110 maintains such information is included in the dermatology package as well as a result received from the laboratory 130 (based on an order request).

For instance, the physician can include a digital image from an examination of a patient. The digital image can be of a dermatological condition of the skin and the physician can determine a pathological test is to be performed on a biopsy. The hub component 110 can receive an electronic dermatology package from the office via the physician that includes at least information defined by the physician as well as an order request for a laboratory to perform a test defined by the physician. The electronic dermatology package in this example includes the digital image from the examination of the patient and will maintain that information to ensure validity and chain-of-custody upon receipt of results from a laboratory. In other words, the information defined by the physician can be included in the results from the laboratory and are validated and authenticated as such information was originally inserted by the physician. The hub component 110 can remove personal information from the electronic dermatology package and communicate the order request and said electronic dermatology package (e.g., without personal information) to the defined laboratory.

The hub component 110 can generate a physical mailing label and/or shipping receipt to include in physical shipping of a physical specimen (e.g., biopsy) to the laboratory, wherein the label or receipt corresponds to the electronic dermatology package and/or order request. According to an example, the mailing label can include an anonymous unique identifier associated with patient identifying information removed from the electronic dermatology package and/or the order request. In an aspect, the hub component 110 replaces the patient identifying information removed from the electronic dermatology package and/or order request with the anonymous unique identifier. Accordingly, the laboratory 130, upon receipt of the physical specimen, can appropriately match the received specimen with the received electronic dermatology package and/or order request via the anonymous unique identifier included on the mailing label. As described above, it is to be appreciated that the anonymous unique identifier can be singly associated with a single order request instance and/or single electronic dermatology package instance transmitted by the hub component to the laboratory 130 as opposed to an association directly with patient identifying information.

For example, the laboratory can receive the order request and physical specimen (e.g., biopsy) and conduct one or more tests requested by the physician. The laboratory can communicate one or more results to the hub component 110, wherein the one or more results include information defined by the physician upon generation of the electronic dermatology package and/or order request. The hub component 110 can be further configured to direct the one or more results to the office environment 120 to, for instance, the physician that initiated the order request and/or determined that a test from a laboratory was to be performed for the patient.

According to a further aspect, the hub component 110, as an intermediary between the office environment 120 and the laboratory 130, can collectively track patients, conditions of the patients, pathology related to the conditions, and healthcare providers treating the patients for the conditions. Accordingly, it can be readily determined whether treatments and pathology services relate to initial service or subsequent service for a problem or condition. Such information is relevant to insurance carrier coverage decisions, for instance.

In another embodiment, the laboratory 130 can be a facility that fills a prescription. For instance, a physician at the office environment 120 can meet a patient and communicate an order request to the laboratory 130 that fills a prescription for the patient, wherein the order request and other information is handled by the hub component 110. In this particular embodiment, the hub component 110 can be configured to include data inserted into the electronic dermatology package by the physician to ensure a chain-of-custody from the office environment 120 to the hub component 110 to the laboratory 130 and from the laboratory 130 to the hub component 110 back to the office environment 120.

It is to be appreciated that, in an embodiment, the hub component 110 can be a stand-alone component (as depicted), incorporated into the office environment 120, incorporated into the laboratory 130, or a suitable combination thereof. Similarly, it is to be appreciated that, in an embodiment, the hub component 110 can be remote to the office environment 120 and/or remote to the laboratory 130. For instance, the hub component 110 can be cloud-based and reside on a first network, whereas the office environment 120 is on a second network and the laboratory is on a third network.

It is to be appreciated that the hub component 110 can be implemented on a device, wherein the device can be, but is not limited to being, a computer, a desktop machine, a tablet, a portable device, a portable digital assistant, a smartphone, a laptop, a computing device, a porting gaming device, a game console, a device that can access the Internet, a kiosk, a terminal, a display, a surface computing device, smart glass, a surface that interacts with a user's motion or touch, and the like.

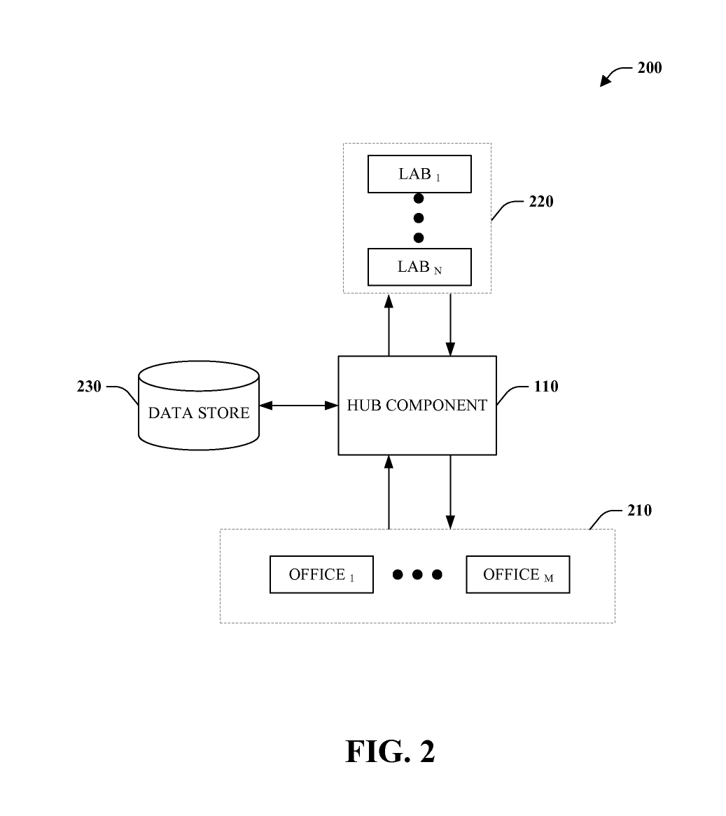

FIG. 2 illustrates a system 200 for validating patient information during requests for laboratory results. The system 200 includes the hub component 110 manages communications of data streams between one or more office environments 210 and one or more laboratories (also referred to as labs) 220. It is to be appreciated that any suitable number of offices 210 can be utilized with the hub component 110 such as, for example, office₁ to office_{M}, where M is a positive integer. Moreover, it is to be appreciated and understood that any suitable number of labs 220 can be utilized with the hub component 110 such as, for example, lab₁ to lab_{N}, where N is a positive integer. For example, a hub component 110 can be utilized for a group of offices that are in physical locations that differ from one another. In another example, the hub component 120 can be utilized with one or more offices based on which health insurance providers are approved or accepted. It is to be appreciated and understood that any suitable characteristics or factors can be employed to determine which office(s) the hub component 110 services. Moreover, the hub component 110 can be defined to communicate order request(s) to particular labs based on criteria defined by a physician (e.g., test performance, test capabilities, equipment, cost, physical location, turn-around time, among others).

The data store 230 can store media from the system 200 such as, but not limited to, data streams, unique identification, patient personal information, order requests, templates for requests, order request targets, office environment information (e.g., source information), laboratory environment information, addresses, shipping details, electronic payment information, cryptology information, passwords, authentication information, and the like. It is to be appreciated that the data store 230 can be, for example, either volatile memory or nonvolatile memory, or can include both volatile and nonvolatile memory. The data store 230 of the subject systems and methods is intended to comprise, without being limited to, these and other suitable types of memory. In addition, it is to be appreciated that the data store 230 can be a server, a database, a hard drive, a flash drive, an external hard drive, a portable hard drive, a cloud-based storage, a solid-state drive, a distributed storage system, and the like. The data store 230 can further be a local data store, a remote data store, a cloud-based data store, or a combination thereof.

FIG. 3 illustrates a system 300 for maintaining confidentiality of patient information with a request for a laboratory test. The hub component 110 can include an identification component 310 (also referred to as ID component 310). The ID component 310 can ensure data communications from the hub component 110 to one or more labs 220 does not include personal information for a patient and/or patient identifying data. In particular, the ID component 310 can utilize a secured data store that matches a unique identifier to the patient data (e.g., order request, electronic dermatology package, etc.). Thus, the ID component 310 ensures that a unique identifier is communicated to the laboratory rather than any personal information. It is to be appreciated that any suitable technique to associate a unique identification to data can be used and the above is solely for example. The ID component 310 can further match a received result from a laboratory and re-associate patient data to the test result.

The hub component 110 can further include an authentication component 320 that can be configured to ensure secure communications between the hub component 110 and the offices 210 and/or communications between the hub component 110 and the labs 220. For instance, the authentication component 320 can utilize cryptography techniques to provide secure transmissions. In an example, encryption and decryption using shared or private keys can be utilized.

The aforementioned systems, components, (e.g., hub component 110, office environment 120, laboratory 130, data store 230, ID component 310, authentication component 320, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

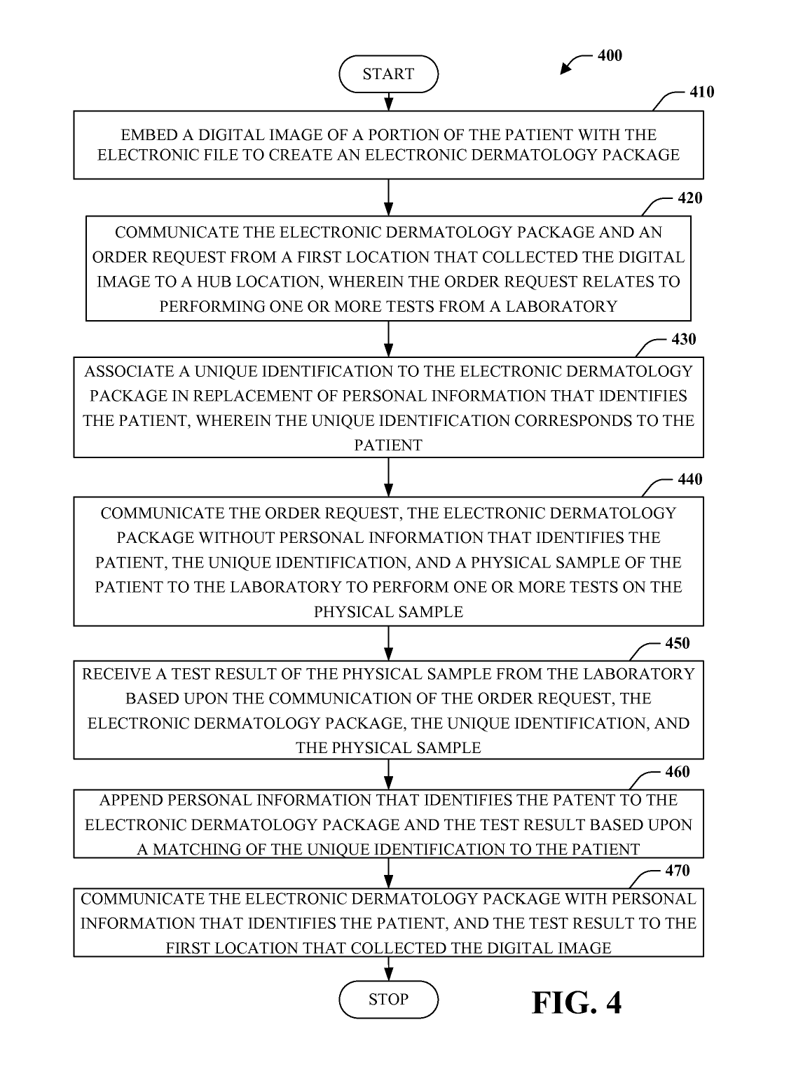

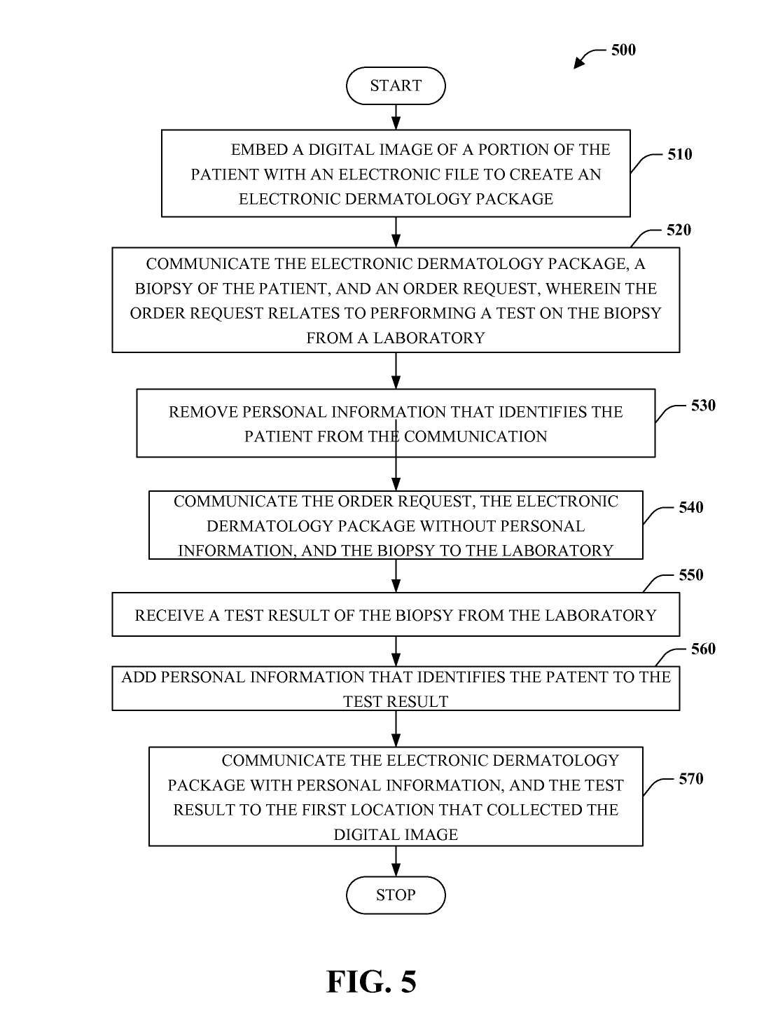

In view of the exemplary devices and elements described supra, methodologies that may be implemented in accordance with the disclosed subject matter will be better appreciated with reference to the flow charts of FIGS. 4-5. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 4 illustrates a flow chart of a method 400 for communicating a request to a laboratory. At reference numeral 410, a digital image of a portion of the patient can be embedded with the electronic file to create an electronic dermatology package. At reference numeral 420, the electronic dermatology package and an order request can be communicated from a first location that collected the digital image to a hub location, wherein the order request relates to performing one or more tests from a laboratory. At reference numeral 430, a unique identification can be associated to the electronic dermatology package in replacement of personal information that identifies the patient, wherein the unique identification corresponds to the patient. At reference numeral 440, the order request, the electronic dermatology package without personal information that identifies the patient, the unique identification, and a physical sample of the patient can be communicated to the laboratory to perform one or more tests on the physical sample.

At reference numeral 450, a test result of the physical sample from the laboratory can be received based upon the communication of the order request, the electronic dermatology package, the unique identification, and the physical sample. At reference numeral 460, personal information that identifies the patient can be appended to the electronic dermatology package and the test result based upon a matching of the unique identification to the patient. At reference numeral 470, the electronic dermatology package with personal information that identifies the patient, and the test result can be communicated to the first location that collected the digital image.

In an embodiment, the one or more tests is at least one of an examination of a biopsy from the patient, a pathology test, an anatomical pathology test, or a clinical pathology test. In the embodiment, the method can include validating the receipt of the test based upon use of a secured channel. In an embodiment, the method can include encrypting the communication of the order request, and the electronic dermatology package without personal information. In an embodiment, the method can include decrypting the receipt of the test from the laboratory.

FIG. 5 illustrates a flow chart of a method 500 for validating information from a physician for a patient file. At reference numeral 510, a digital image of a portion of the patient can be embedded with an electronic file to create an electronic dermatology package. At reference numeral 520, the electronic dermatology package, a biopsy of the patient, and an order request can be communicated, wherein the order request relates to performing a test on the biopsy from a laboratory. At reference numeral 530, personal information that identifies the patient can be removed from the communication. At reference numeral 540, the order request, the electronic dermatology package without personal information, and the biopsy can be communicated to the laboratory. At reference numeral 550, a test result of the biopsy can be received from the laboratory. At reference numeral 560, personal information that identifies the patient can be added to the test result. At reference numeral 570, the electronic dermatology package with personal information, and the test result can be communicated to the first location that collected the digital image.

In an embodiment, the digital image is of a portion of skin of the patient. In an embodiment, the portion of skin includes a dermatology-based medical condition. In an embodiment, the laboratory is a pathology lab to perform one or more pathology tests on the biopsy. In an embodiment, the method can include integrating a note from a physician of the first location with the electronic dermatology package; and maintaining a chain of custody with the note and the electronic dermatology package during communication of the order request and receipt of the test result.

In an embodiment, the method can include validating the receipt of the test result of the biopsy from the laboratory based upon use of a secured channel. In an embodiment, the method can include encrypting the communication of the order request, and the electronic dermatology package without personal information. In an embodiment, the method can include decrypting the receipt of the test result of the biopsy from the laboratory.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

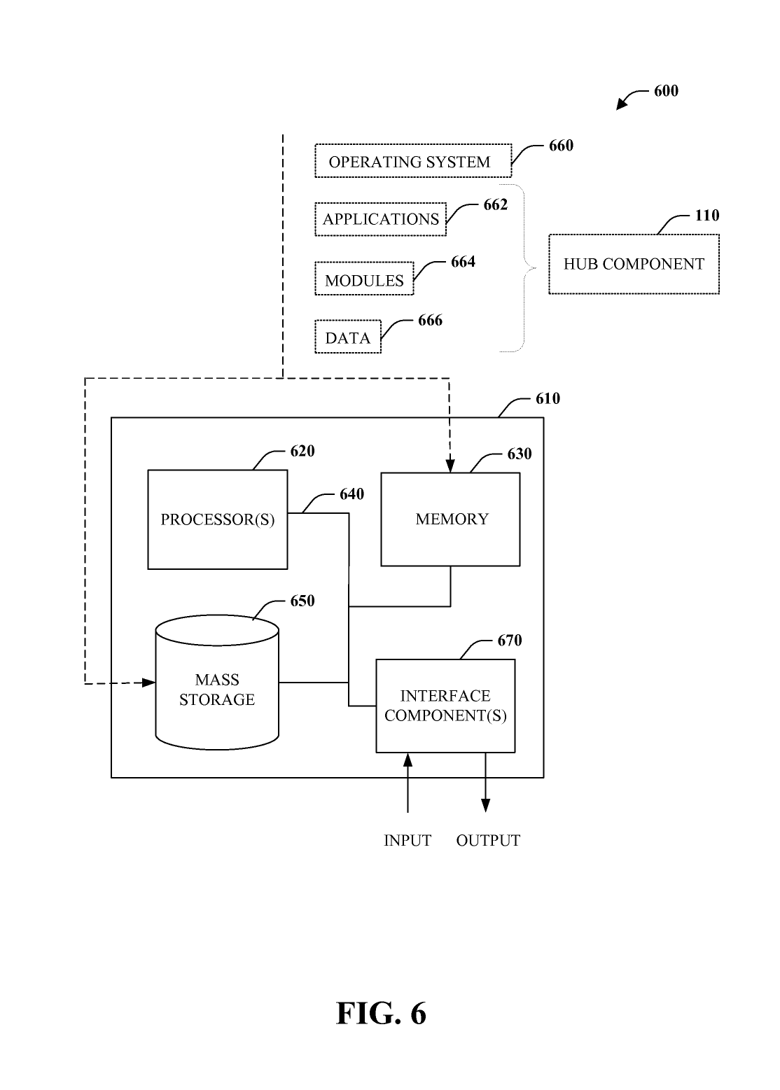

In order to provide a context for the claimed subject matter, FIG. 6 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), portable gaming device, smartphone, tablet, Wi-Fi device, laptop, phone, among others), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 6, illustrated is an example general-purpose computer 610 or computing device (e.g., desktop, laptop, server, hand-held, programmable consumer or industrial electronics, set-top box, game system . . . ). The computer 610 includes one or more processor(s) 620, memory 630, system bus 640, mass storage 650, and one or more interface components 670. The system bus 640 communicatively couples at least the above system components. However, it is to be appreciated that in its simplest form the computer 610 can include one or more processors 620 coupled to memory 630 that execute various computer executable actions, instructions, and or components stored in memory 630.

The processor(s) 620 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 620 may also be implemented as a combination of computing devices, for example a combination of a DSP and a microprocessor, a plurality of microprocessors, multi-core processors, one or more microprocessors in conjunction with a DSP core, or any other such configuration.

The computer 610 can include or otherwise interact with a variety of computer-readable media to facilitate control of the computer 610 to implement one or more aspects of the claimed subject matter. The computer-readable media can be any available media that can be accessed by the computer 610 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 610.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 630 and mass storage 650 are examples of computer-readable storage media. Depending on the exact configuration and type of computing device, memory 630 may be volatile (e.g., RAM), non-volatile (e.g., ROM, flash memory . . . ) or some combination of the two. By way of example, the basic input/output system (BIOS), including basic routines to transfer information between elements within the computer 610, such as during start-up, can be stored in nonvolatile memory, while volatile memory can act as external cache memory to facilitate processing by the processor(s) 620, among other things.

Mass storage 650 includes removable/non-removable, volatile/non-volatile computer storage media for storage of large amounts of data relative to the memory 1030. For example, mass storage 650 includes, but is not limited to, one or more devices such as a magnetic or optical disk drive, floppy disk drive, flash memory, solid-state drive, or memory stick.

Memory 630 and mass storage 650 can include, or have stored therein, operating system 660, one or more applications 662, one or more program modules 664, and data 666. The operating system 660 acts to control and allocate resources of the computer 610. Applications 662 include one or both of system and application software and can exploit management of resources by the operating system 660 through program modules 664 and data 666 stored in memory 630 and/or mass storage 650 to perform one or more actions. Accordingly, applications 662 can turn a general-purpose computer 610 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the hub component 110, or portions thereof, can be, or form part, of an application 662, and include one or more modules 664 and data 666 stored in memory and/or mass storage 650 whose functionality can be realized when executed by one or more processor(s) 620.

In accordance with one particular embodiment, the processor(s) 620 can correspond to a system on a chip (SOC) or like architecture including, or in other words integrating, both hardware and software on a single integrated circuit substrate. Here, the processor(s) 620 can include one or more processors as well as memory at least similar to processor(s) 620 and memory 630, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the hub component 110 and/or associated functionality can be embedded within hardware in a SOC architecture.

The computer 610 also includes one or more interface components 670 that are communicatively coupled to the system bus 640 and facilitate interaction with the computer 610. By way of example, the interface component 670 can be a port (e.g., serial, parallel, PCMCIA, USB, FireWire . . . ) or an interface card (e.g., sound, video . . . ) or the like. In one example implementation, the interface component 670 can be embodied as a user input/output interface to enable a user to enter commands and information into the computer 610 through one or more input devices (e.g., pointing device such as a mouse, trackball, stylus, touch pad, keyboard, microphone, joystick, game pad, satellite dish, scanner, camera, other computer . . . ). In another example implementation, the interface component 670 can be embodied as an output peripheral interface to supply output to displays (e.g., CRT, LCD, plasma . . . ), speakers, printers, and/or other computers, among other things. Still further yet, the interface component 670 can be embodied as a network interface to enable communication with other computing devices (not shown), such as over a wired or wireless communications link.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method for communication between a physician office and a laboratory, comprising:
receiving, form the physician office, an electronic data package associated with a patient and an order request indicating one or more diagnostic tests to be performed;
removing patient identification information from the electronic data package and the order request;
transmitting the electronic data package and the order request, with patient identification information removed, to the laboratory;
receiving results of the one or more diagnostic tests from the laboratory; and
transmitting the electronic data package and the results to the physician office.

2. The method of claim 1, further comprising:
generating a unique identifier; and
replacing the patient identification information removed from the electronic data package and the order request with the unique identifier.

3. The method of claim 2, wherein the unique identifier is generated in correspondence to the patient identification information.

4. The method of claim 2, wherein the unique identifier is generated in correspondence to the order request.

5. The method of claim 2, wherein receiving the results further comprises receiving the results from the laboratory in association with the unique identifier included in the electronic data package and the order request transmitted to the laboratory.

6. The method of claim 5, further comprising associating the results from the laboratory with patient identification information based on the unique identifier.

7. The method of claim 1, further comprising appending the results of the one or more diagnostic tests to the electronic data package.

8. The method of claim 1, further comprising restoring the patient identification information to the electronic data package before transmission of the electronic data package and the results to the physician office.

9. The method of claim 1, further comprising generating a mailing label for a sample obtained at the physician office, wherein the sample is subject to the one or more diagnostic tests, and the mailing label includes an identifier to associate the sample with the electronic data package and the order request.

10. The method of claim 1, wherein the electronic data package incorporates information related to a patient, a healthcare provider, and a condition.

11. A method of validating information from a physician for a patient file, comprising:
embedding a digital image of a portion of the patient with an electronic file to create an electronic dermatology package;
communicating the electronic dermatology package, a biopsy specimen of the patient, and an order request, wherein the order request relates to performing a test on the biopsy specimen from a laboratory;
removing personal information that identifies the patient from the communication;
communicating the order request, the electronic dermatology package without personal information, and the biopsy specimen to the laboratory;
receiving a test result of the biopsy specimen from the laboratory;
adding personal information that identifies the patent to the test result; and
communicating the electronic dermatology package with personal information, and the test result to the first location that collected the digital image.

12. The method of claim 11, wherein the digital image is of a portion of skin of the patient.

13. The method of claim 12, wherein the portion of skin includes a dermatology-based medical condition.

14. The method of claim 11, wherein the laboratory is a pathology lab to perform one or more pathology tests on the biopsy specimen.

15. The method of claim 11, further comprising:
integrating a note from a physician of the first location with the electronic dermatology package; and
maintaining a chain of custody with the note and the electronic dermatology package during communication of the order request and receipt of the test result.

16. The method of claim 11, further comprising validating the receipt of the test result of the biopsy specimen from the laboratory based upon use of a secured channel.

17. The method of claim 11, further comprising encrypting the communication of the order request, and the electronic dermatology package without personal information.

18. The method of claim 17, further comprising decrypting the receipt of the test result of the biopsy from the laboratory.

19. A method of communicating a request to a laboratory, comprising:
creating an electronic file for a patient that includes dermatology information associated with the patient;
embedding a digital image of a portion of the patient with the electronic file to create an electronic dermatology package;
communicating the electronic dermatology package and an order request from a first location that collected the digital image to a hub location, wherein the order request relates to performing one or more tests from a laboratory;
removing personal information that identifies the patient from the electronic dermatology package;
associating a unique identification to the electronic dermatology package in replacement of personal information that identifies the patient, wherein the unique identification corresponds to the patient;
communicating the order request, the electronic dermatology package without personal information that identifies the patient, the unique identification, and a physical sample of the patient to the laboratory to perform one or more tests on the physical sample;
receiving a test result of the physical sample from the laboratory based upon the communication of the order request, the electronic dermatology package, the unique identification, and the physical sample;
appending personal information that identifies the patent to the electronic dermatology package and the test result based upon a matching of the unique identification to the patient; and
communicating the electronic dermatology package with personal information that identifies the patient, and the test result to the first location that collected the digital image.

20. The method of claim 19, wherein the one or more tests is at least one of an examination of a biopsy from the patient, a pathology test, an anatomical pathology test, or a clinical pathology test.
